(19) United States
(12) Patent Application Publication
(10) Pub. No.: US 2026/0012841 A1
(43) Pub. Date: Jan. 8, 2026

(54) ENHANCED PDCP OPERATION FOR DELAY-CRITICAL SERVICES

(71) Applicant: Lenovo (Singapore) Pte Ltd, Singapore (SG)

(72) Inventors: Joachim Löhr, Wiesbaden (DE); Shwetha Sreejith, Steinbach (DE); Prateek Basu Mallick, Dreieich (DE)

(73) Assignee: Lenovo (Singapore) Pte Ltd, Singapore (SG)

(21) Appl. No.: 18/763,718

(22) Filed: Jul. 3, 2024

(51) Int. Cl. H04W 28/02; H04L 47/28; H04W 28/06

(52) U.S. Cl. CPC H04W 28/0268; H04L 47/28; H04W 28/06

(57) ABSTRACT

Various aspects of the present disclosure relate to enhanced packet data convergence protocol (PDCP) operation for delay-critical services. An apparatus, such as a user equipment (UE), receives a configuration message for a PDCP entity of the UE. The configuration message indicates a set of timer configurations corresponding to a set of priority levels (e.g., protocol data unit (PDU) priority levels). A network equipment (NE) configures a mapping between the set of timer configurations and the set of priority levels and transmits the configuration message according to the mapping. The PDCP entity receives at least one service data unit (SDU) for transmission. The SDU is associated with a radio bearer and a priority level of the set of priority levels. The UE selects a timer configuration from the set of timer configurations based on the priority level associated with the SDU. The UE initiates a timer according to the timer configuration.

### TECHNICAL FIELD

The present disclosure relates to wireless communications, and more specifically to enhanced packet data convergence protocol (PDCP) operation for delay-critical services.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling. Some wireless communications systems support extended reality (XR) services, including augmented reality (AR) and virtual reality (VR), as well as cloud gaming (CG). To provide satisfactory user experiences, XR services require high bit rates with bounded latency and therefore are delay-critical. Additionally, XR applications require a certain minimum granularity of application data to be available on the client side before the next level of processing can start. This minimum granularity of application data may be referred to as an application data unit (ADU) or a protocol data unit (PDU) set.

In some cases, an ADU or PDU set represents the smallest unit of data that can be processed independently by an application, such as an intra-coded frame (I-frame), a predictive-coded frame (P-frame), or the like. A PDU set can be one or more I-slices, P-slices, I-frame, P-frame, or a combination thereof. For instance, a quality of service (QOS) flow (e.g., a radio bearer) for XR traffic may carry PDU sets with respective importance levels (e.g., PDU set importance (PSI) levels), such as I-frames and P-frames. A given P-frame may depend on an I-frame for successful decoding at a receiver device, such that the I-frame has a relatively higher importance level than the P-frame. In conventional QoS architectures, all data packets (e.g., PDUs), regardless of importance level, carried by a radio bearer experience the same QoS treatment. As a result, however, a device may discard PDU sets with relatively higher importance levels, such as I-frames, such that lower importance (e.g., dependent) P-frames are unable to be decoded. Failure to decode these dependent P-frames may cause service interruption, increased latency, and negatively impact user experience.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein include a UE for wireless communication to receive, from a radio access network (RAN), a configuration message for a packet data convergence protocol (PDCP) entity of the UE, the configuration message indicating a set of timer configurations corresponding to a set of priority levels; receive, at the PDCP entity, at least one service data unit (SDU) for transmission, the SDU associated with a radio bearer and a priority level of the set of priority levels; and select a timer configuration from the set of timer configurations based at least in part on the priority level associated with the SDU.

In some implementations of the method and apparatuses described herein, the UE initiates a timer based on reception of the SDU associated with the radio bearer, and the timer configuration indicates a timer duration for the timer. The timer is a PDCP discard timer. The set of timer configurations includes at least a first timer configuration corresponding to a higher priority level of the set of priority levels, a second timer configuration corresponding to a lower priority level of the set of priority levels, and a third timer configuration corresponding to a legacy timer configuration. The first timer configuration indicates a first timer duration that is greater than a second timer duration associated with the second timer configuration and a third timer duration associated with the third timer configuration. To select the timer configuration, the UE selects the first timer configuration based on the SDU being associated with the higher priority level. The UE initiates a first timer associated with the first timer configuration after expiry of a second timer associated with the legacy timer configuration. The UE initiates the first timer prior to delivery of the SDU to a lower layer for the transmission. The UE transmits the SDU prior to expiry of the first timer. The UE discards the SDU after expiry of the first timer. The UE determines the priority level associated with the SDU based at least in part on the SDU being a reference for decoding one or more other SDUs. The UE selects the timer configuration based at least in part on PSI-based discard being enabled or disabled. The configuration message indicates a mapping between the set of timer configurations and the set of priority levels. Each priority level of the set of priority levels corresponds to a respective PSI level. The configuration message indicates a respective delay status report (DSR) threshold associated with each timer configuration of the set of timer configurations. The UE receives PDU set information indicating at least one of the priority levels of the set of priority levels, a PSI level associated with the SDU, or whether the SDU is a reference for decoding one or more other SDUs. The UE indicates, within a PDCP header of the SDU, whether the SDU is to be delivered to an upper layer after expiry of a PDU set delay budget (PSDB).

Some implementations of the method and apparatuses described herein further include a processor for wireless communication to receive, from a radio access network, a configuration message for a PDCP entity associated with the processor, the configuration message indicating a set of timer configurations corresponding to a set of priority levels; receive, at the PDCP entity, at least one SDU for transmission, the SDU associated with a radio bearer and a priority level of the set of priority levels; and select a timer configuration from the set of timer configurations based at least in part on the priority level associated with the SDU.

Some implementations of the method and apparatuses described herein further include a method performed by a UE, the method including receiving, from a radio access network, a configuration message for a PDCP entity of the UE, the configuration message indicating a set of timer configurations corresponding to a set of priority levels; receiving, at the PDCP entity, at least one SDU for transmission, the SDU associated with a radio bearer and a priority level of the set of priority levels; and selecting a timer configuration from the set of timer configurations based at least in part on the priority level associated with the SDU.

Some implementations of the method and apparatuses described herein further include an NE for wireless communication to configure, for a PDCP entity of a UE, a mapping between a set of timer configurations and a set of priority levels; and transmit, to the UE, a configuration message indicating the set of timer configurations corresponding to the set of priority levels.

### BRIEF DESCRIPTION OF THE DRAWINGS

FIG. 1 illustrates an example of a wireless communications system in accordance with aspects of the present disclosure.

FIG. 2 illustrates an example protocol stack, in accordance with aspects of the present disclosure.

FIG. 3 illustrates an example user plane protocol stack, in accordance with aspects of the present disclosure.

FIG. 4 illustrates an example PDCP control PDU, in accordance with aspects of the present disclosure.

FIGS. 5A and 5B illustrate an example PDCP configuration information element, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) support wireless communication (e.g., reception and/or transmission of wireless communication) via an over-the-air interface, e.g., as part of a RAN. For example, the UE and the NE may communicate XR traffic, such as video frames, for XR services, which may include high resolution video and audio streams. XR traffic can be quasi-periodic with non-negligible jitter and is characterized by relatively high bit rates and relatively strict latency requirements. For instance, video and audio streams at high resolutions require substantial bandwidth. Additionally, to maintain a seamless and immersive user experience, XR applications require relatively high reliability and relatively low latency that is relatively consistent and/or predictable (e.g., low jitter). XR traffic may be referred to or understood as delay-critical traffic, time sensitive communications (TSC), time critical communications, or the like. To support sufficient performance and ensure that requirements are met, the UE and the NE implement QoS mechanisms to prioritize XR traffic over less delay-sensitive traffic types. Moreover, within XR traffic, some video frame types are associated with a higher importance than other video frame types. A video frame may include or be an example of an I-frame, a P-frame, an I-slice, and/or a P-slice. I-frames and I-slices may be used to decode corresponding P-frames and P-slices and, as such, may be associated with higher importance levels than P-frames and P-slices. A PDU set may include or be an example of one or more I-slices, P-slices, I-frames, P-frames, or a combination thereof.

Latency requirements of XR traffic are represented as packet delay budgets (PDBs). A PDB is defined as a limited time budget for a packet to be transmitted over the air from an NE to a UE. A PDB for a PDU set is a PSDB. For a given packet (e.g., SDU, PDU, ADU), the delay of the packet incurred via the over-the-air interface is measured from the time that the packet arrives at the NE to the time that it is successfully transferred to the UE. If the delay is larger than the PDB configured for the packet, the packet is said to violate the PDB; otherwise, the packet is considered as successfully delivered. Additionally, a PDU set may be considered as successfully delivered only when all PDUs of the PDU set have been successfully delivered. In some examples, the UE and the NE exchange PDB information (e.g., DSR). For instance, the NE transmits, to the UE and for one or more packets of a video frame, slice, and/or ADU, an indication (e.g., downlink control information (DCI), media access control (MAC) control element (MAC-CE)) of a remaining delay budget for a downlink transmission. Similarly, the UE transmits, to the NE, an indication (e.g., uplink control information, physical uplink shared channel (PUSCH)) of a remaining delay budget for an uplink transmission.

In some cases, the NE and the UE communicate based on delay budgets for traffic packets (e.g., PDU sets, PDUs, etc.), which may be referred to as delay-aware communication. For example, if a scheduling NE and/or the UE are aware of delay budgets for a packet/PDU set, the scheduling NE may give priority to transmissions that are close to their delay budget limit, and/or may refrain from scheduling other transmissions (e.g., uplink transmissions). Additionally, the UE may utilize delay budget information to determine if an UL transmission (e.g., a physical uplink control channel (PUCCH) transmission in response to a physical downlink shared channel (PDSCH) transmission, an UL pose transmission, or a PUSCH transmission) corresponding to a transmission that exceeds its delay budget can be dropped by the UE. Moreover, in such scenarios, the UE may not wait for retransmission of a PDSCH and may not keep any erroneously received PDSCH in a buffer (e.g., for soft combining with a retransmission that never occurs). Additionally, or alternatively, the UE may determine how much of its channel occupancy time (e.g., when using an unlicensed spectrum) can be shared with the NE.

Jitter in XR traffic can impact layer 2 (L2) (e.g., PDCP layer, radio link control (RLC) layer, MAC layer) procedures. Due to jitter, two or more PDU sets may be interleaved upon delivery to a transmitting PDCP entity (e.g., layer) of a device (e.g., a UE), such that respective SDUs of the two or more different PDU sets are not received in order (e.g., in sequential order) at the transmitting PDCP entity. To ensure that PDU sets are transmitted within their associated PSDB, an RLC entity of the device (e.g., a UE) may implement RLC prioritization, in which the device prioritizes transmission of PDUs and/or SDUs belonging to a PDU set for which a remaining time (e.g., of an associated PSDB) is close to zero. These PDUs and/or SDUs may be referred to as delay-critical data. In RLC prioritization, the RLC entity may change a transmission order (referred to as changing a sequence number (SN) order) to deliver delay-critical PDUs and/or SDUs ahead of non-delay-critical PDUs and/or SDUs to a lower layer (e.g., a MAC layer) for transmission.

Changing a transmission order at a transmitting device to prioritize delay-critical PDUs and/or SDUs may trigger a reordering operation at a receiving device. As an example, a receiving PDCP entity initiates reordering when PDCP PDUs are received out of order, e.g., when a gap (e.g., an SN gap) exists in a reception window of the PDCP receiving entity. However, the time taken by performing the reordering operation at the receiving PDCP entity delays delivery of delay-critical PDUs and/or SDUs to higher layers, such that meeting the PSDB may no longer be possible. Additionally, when reordering is triggered, the receiving device starts a timer (e.g., t-reordering), and does not move the reception window forward until the timer expires. Moreover, in some scenarios (e.g., when the receiving device is an NE receiving uplink XR traffic), the receiving PDCP entity may not be aware of importance levels corresponding to received PDUs and/or SDUs. Without moving the reception window forward and/or without awareness of importance levels, PDUs and/or SDUs of a delay-critical PDU set can remain stuck in a reception buffer of the receiving device for as long as the t-reordering timer is running, and thus the PSDB cannot be met.

Violation of a PDB and/or PSDB has consequences that degrade communication performance and user experience. In real-time XR applications, for example, exceeding the PDB and/or PSDB can result in noticeable lag, buffering, playback interruptions, or a decrease in video quality. Moreover, packets that arrive late (e.g., after PDSB expiry) may no longer be useful and may be discarded using PDU set discarding. Some PDU set discarding mechanisms are timer-based. For example, at a transmitting PDCP entity, a discard timer (e.g., discardTimer) may be configured for each data radio bearer (DRB) or PDCP entity. Upon reception of a PDCP SDU from an upper layer, the transmitting PDCP entity initiates a discard timer associated with the PDCP SDU. When the discard timer expires, if successful reception of the PDCP is not confirmed, the transmitting PDCP entity discards the PDCP SDU. However, conventional PDU set discard mechanisms do not distinguish between high- and low-importance PDU sets. Thus, if a transmitting PDCP entity discards PDUs and/or SDUs belonging to high importance PDU set(s) which are necessary for the decoding of dependent PDU sets, the other dependent PDU sets cannot be decoded successfully, causing lag, playback interruptions, and other performance degradations.

The techniques described herein provide improved transmission of delay-critical (e.g., urgent) data by enhancing PDCP receiving and transmitting procedures. For example, aspects of the present disclosure enable a transmitting PDCP entity to transmit high-importance PDU sets even when a corresponding PSDB has been exceeded, e.g., when a corresponding PDCP discard timer has expired. In some embodiments, a UE is configured (e.g., by a network and/or an NE) with a set of timer configurations corresponding to a set of importance levels (e.g., priority levels) for XR traffic (e.g., PDUs, PDU sets, SDUs, ADUs). For instance, a network (e.g., an NE) configures a set of PDCP discard timers for a PDPC entity of the UE, and the PDPC entity applies a PDCP discard timer of the set of PDPC discard timers for an SDU of a PDU set associated with an importance level of the set of importance levels. PDCP discard timers associated with higher importance levels have longer time durations compared to legacy PDCP discard timers and PDCP discard timers associated with lower importance levels, thereby improving the likelihood that important PDU sets and subsequent dependent PDU sets are successfully decoded and delivered to an application layer.

Additionally, the techniques described herein enable PDUs and/or SDUs received out of sequence order (e.g., due to prioritization at a transmitting RLC entity) to be delivered to upper layers without delay (e.g., delay caused by being stuck in a reception buffer). Aspects of the present disclosure provide PDCP control information signaled from a transmitting PDCP entity to a receiving PDCP entity. In embodiments, the PDCP control information includes or is an example of a PDCP control PDU that indicates an SN or count value of one or more PDCP SDUs (e.g., stored in a reception buffer of the receiving PDCP entity) which are to be delivered (e.g., out of order) immediately to an upper layer. The receiving PDCP entity delivers, to the upper layer, the PDCP SDUs identified by the corresponding SN or count value even when a reordering timer (e.g., t-reordering) is running.

The described techniques further relate to header information (e.g., general packet radio service (GPRS) tunnelling protocol (GTP) for the user plane (GTP-U) header information) indicating whether a PDCP PDU and/or SDU should be delivered out of order to the upper layer. In implementations, a field within PDU set information indicates whether a PDU set is used as a reference for decoding other PDU sets. The field includes or is an example of a PDU set information parameter and, in some cases, is indicated along with a PSI indication, e.g., in a GTP-U header from a user plane function (UPF) to an NE (e.g., a gNB). When the PDU set information parameter indicates that a given PDU set is used to decode dependent PDU set(s), PDUs and/or SDUs belonging to the PDU set are transmitted even when a corresponding PSDB has been exceeded, e.g., the PDU set should not be discarded when the PSDB is exceeded. Further, the PDUs and/or SDUs belonging to the PDU set are delivered, by the receiving PDCP entity, out of order to upper layers. Similarly, the PDU set information indicating whether a PDU set is used as a reference for decoding other PDU sets is provided to the Access Stratum (AS) in the UE, e.g., from an application layer.

Aspects of the present disclosure support improved L2 procedures for distinguished handling of PDU sets according to corresponding importance levels, which may improve communications performance and reduce negative impacts to user experience. For example, by implementing multiple PDCP discard timers as described herein, a transmitting PDCP entity can prioritize transmission of high-importance PDUs and/or SDUs and discard low-importance PDUs and/or SDUs, which may reduce traffic congestion and reduce latency. Transmitting PDUs and/or SDUs associated with a high-importance PDU set even after a corresponding PSDB is exceeded ensures that subsequent dependent PDU sets can be decoded and delivered to upper layers such as an application layer, thereby preventing negative impacts to user experience. Additionally, by performing the described techniques, a receiving PDCP entity can provide timely delivery of correctly received PDUs and/or SDUs to a higher layer even though the PDUs and/or SDUs are delivered out of order, e.g. while t-reordering is running. For instance, the transmitting PDCP entity provides the PDCP receiving entity with PDCP information (e.g., PDCP control information, PDU set information) that identifies PDUs and/or SDUs to be delivered out of order to upper layers, enabling the receiving PDCP entity to avoid discarding delay-critical PDUs and/or SDUs.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

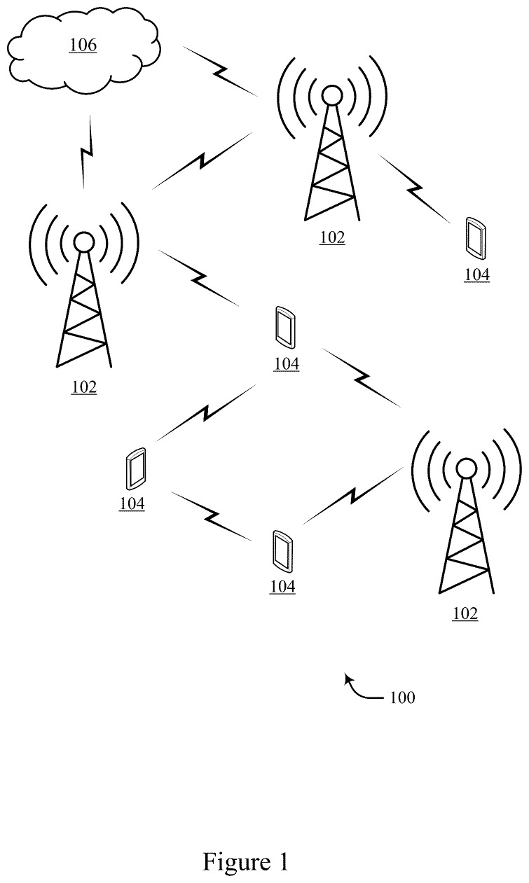

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A PDCP entity is a component within network architecture that is responsible for handling specific PDCP functions for a particular radio bearer. A radio bearer is a logical channel that carries data between wireless devices of the wireless communications system 100, such as NEs 102, UEs 104, and the CN 106. Each radio bearer is associated with a respective transmitting PDCP entity and a respective receiving PDCP entity which ensures proper handling and processing of data packets. For instance, a transmitting PDCP entity of a PDCP layer receives PDUs and/or SDUs from upper layers, processes the PDUs and/or SDUs, and sends them to an RLC layer. The RLC layer handles transmission over the air interface through MAC and physical (PHY) layers.

The wireless communications system 100 may support XR services and XR applications as described herein. XR is an umbrella term for different types of realities and refers to all real-and-virtual combined environments and human-machine interactions generated by computer technology and wearables. It includes representative forms such as AR, VR, CG, and mixed reality (MR) and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

VR is a rendered version of a delivered visual and audio scene. The rendering is designed to mimic visual and audio sensory stimuli of the real world as naturally as possible to an observer or user as they move within the limits defined by the application. VR may require a user to wear a head mounted display (HMD) to completely replace the user's field of view with a simulated visual component, and to wear headphones to provide the user with the accompanying audio. Some form of head and motion tracking of the user in VR is often performed to allow the simulated visual and audio components to be updated in order to ensure that, from the user's perspective, items and sound sources remain consistent with the user's movements. Additional means to interact with the virtual reality simulation can be provided.

In AR, a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed. MR is an advanced form of AR where some virtual elements are inserted into the physical scene with the intent to provide the illusion that these elements are part of the real scene.

XR services have a certain variety and characteristics of data streams (e.g., video streams) and may change “on-the-fly,” e.g., while the XR services are running over NR. Therefore, additional information on running services from higher layers, e.g. a QoS flow association, frame-level QoS, PDU set-based QoS, XR specific QoS, etc., can facilitate informed choices of radio parameters by communicating devices (e.g., the UE(s) 104, the NE(s) 102). XR application awareness by the UEs 104 and the NEs 102 in this manner can improve user experience, improve system capacity in supporting XR services, and reduce UE power consumption.

Packet or data burst arrival times in XR may be quasi-periodic, i.e., periodic with jitter. Many XR use cases are characterized by quasi-periodic traffic (with possible jitter) with high data rate in the downlink (e.g., video streams) combined with frequent uplink (e.g., pose transmissions, control update transmissions) and/or uplink video streams. Both downlink and uplink traffic are also characterized by relatively strict PDBs. Some factors leading to jitter in arrival times include varying server render times, encoder times, real-time transport protocol (RTP) packetization times, link characteristics between a server and a 5G gateway, and the like. Increased jitter reduces reliability and increases latency of XR traffic, which, in turn, degrades performance and user experience.

Jitter present in XR may be simulated or modeled using a truncated Gaussian distribution with a mean equal to 0 milliseconds (ms), a standard deviation of 2 ms, a baseline range of [−4 ms, 4 ms], and an optional range [−5 ms, 5 ms]. A packet arrival rate may be determined by a frame generation rate (e.g., 60 frames per second (fps)). Accordingly, an average packet arrival periodicity is given by the inverse of the frame rate (e.g., 16.6667 ms=1/60 fps). A periodic arrival without jitter gives an arrival time in milliseconds (ms) at an NE for a packet with index k (=1, 2, 3 . . . ) as shown in Equation 1 below, where F is the given frame generate rates (per second).

$$\frac{k}{F * 1000} \qquad ( 1 )$$

This periodic packet arrival implicitly assumes a fixed delay contributed from the network side including a fixed video encoding time, fixed network transfer delay, and so forth. However, in a real system, variations in frame encoding delay and network transfer times introduce jitter in packet arrival times. Jitter may be modelled as a random variable added on top of periodic packet arrivals. The jitter follows a truncated Gaussian distribution with statistical parameters as shown in Table 1.

TABLE 1

| | | Baseline value for | Optional value for |
|---|---|---|---|
| Parameter | Unit | evaluation | evaluation |
| Mean | ms | 0 | |
| STD | ms | 2 | |
| Truncation range | ms | [−4, 4] | [−5, 5] |

Note that the given parameter values and considered frame generation rates (60 or 120 in this model) ensure that packet arrivals are in order (i.e., arrival time of a next packet is always larger than that of the previous packet). Thus, the periodic arrival with jitter gives the arrival time in ms for packet with index k (=1, 2, 3 . . . ) as shown in equation 2 below, where F is the given frame generation rates (per second) and J is a random variable capturing jitter. Note that actual traffic arrival timing of traffic for each UE 104 could be shifted by the UE 104-specific arbitrary offset.

$$offset + \frac{k}{F * 1000} + J \qquad ( 2 )$$

XR traffic includes bursts of traffic (e.g., data bursts) that can carry one or more PDU sets, where a PDU set includes one or more PDUs and/or SDUs each carrying a payload of one unit of information generated at the application level (e.g., a frame or a video slice). However, conventional QoS parameters specified for packets may not adequately capture XR application requirements in terms of PDU sets. For example, XR applications and services may have delay requirements for a PDU set (e.g., PSDB) that are not adequately translated into PDB requirements. For example, if a PSDB is 10 ms, a corresponding PDB can be set to 10 ms only if all packets (e.g., PDUs and/or SDUs) of the PDU set arrive at the same time. If the packets are spread out, then the PSDB is measured either in terms of the arrival of the first packet of the PDU set or the last packet of the PDU set. In either case, a given PSDB will result in different PDB requirements for different packets of the PDU set.

Accordingly, PSDBs and other QoS parameters can be specifically configured for XR traffic. For example, enhanced XR application awareness (also referred to as “XR-awareness”) relies on QoS flow management, PDU sets, data bursts, and traffic assistance information to provide sufficient performance and user experience considering the characteristics of XR traffic, including the presence of jitter. QoS flow management involves setting up QoS flows with configured parameters such as a guaranteed bit rate (GBR) and a maximum bit rate (MBR). XR traffic is then assigned to a QoS flow configured with high priority, low latency, and high reliability settings. To enable PDU set-based QoS handling for XR traffic, PDU set QoS parameters are provided by a session management function (SMF) of a network to an NE 102, e.g., as part of a QoS profile of a QoS flow. These PDU set QoS parameters may include a PSDB, a PDU set error rate (PSER), and/or PDU set integrated handling information (PSIHI), among other examples. The PDU set QoS parameters are common for (e.g., shared among) all PDU sets mapped to a QoS flow.

A PSDB is defined as an upper bound for the duration between the reception time (e.g., at a UPF of the CN 106 for downlink, at a UE 104 for uplink) of a first PDU and/or SDU of a PDU set and the time when all PDUs and/or SDUs of the PDU set have been successfully received (e.g., at the UE 104 for downlink, at the UPF for uplink). An access network (AN) PSDB is derived by subtracting a CN PDB from the PSDB. A QoS flow is associated with only one PSDB, and when available, the PSDB applies to both downlink and uplink and supersedes a PDB of the QoS flow. The PSER is defined as an upper bound for a rate of non-congestion-related PDU set losses between an NE 102 and a UE 104. A QOS flow is associated with only one PSER, and when available, the PSER applies to both downlink and uplink and supersedes a packet error rate (PER) of the QoS flow. The PSIHI may indicate whether all PDUs and/or SDUs of a PDU set are needed for an application layer to use the PDU set.

Traffic assistance information may include any traffic-related information signaled between the CN 106, the NE 102, and the UE 104. For example, a UPF of the CN 106 identifies PDUs and/or SDUs that belong to PDU sets and determines corresponding PDU set information conveyed to the NE 102, e.g., within a GTP-U header. The PDU set information may include, but is not limited to, a PDU set SN, an indication of an end PDU of the PDU set, a PDU SN within a PDU set, a PDU set size in bytes, and a PSI (e.g., to identify a relative importance of a PDU set compared to other PDU sets within the same QoS flow).

In some examples, traffic assistance information is also provided by the CN 106 to the NE 102. For example, the CN 106 communicates TSC assistance information (TSCAI) for both GBR QoS flows and non-GBR QoS flows, which may include uplink periodicity, downlink periodicity, N6 jitter information (e.g., between the UPF and data network) associated with the downlink periodicity, and the like. As another example, traffic assistance information may include an indication of an end of a data burst, for instance, indicated in a GTP-U header of a last PDU in downlink.

In uplink resource allocation, the NE 102 may not be aware of an exact arrival time of uplink data in a buffer of the UE 104 and, thus, may not have an accurate estimate of a remaining time of data pending in the buffer of the UE 104 for transmission. Accordingly, the UE 104 may provide traffic assistance information to the NE 102 that indicates a remaining time (e.g., a remaining delay budget) of data pending in the buffer. For example, the traffic assistance information may indicate a remaining delay budget of the data for which uplink resources are requested (e.g., by the UE 104). This traffic assistance information may include or be an example of DSR. The UE 104 transmits DSR to the NE 102 to report statuses of received data packets, including any delays encountered in their delivery. In some examples, such as in XR-specific logical channel groups (LCGs), the UE 104 transmits a DSR-specific MAC-CE that indicates an amount of data available for transmission and some remaining delay information associated with the indicated data. In some cases, the UE 104 and the NE 102 implement threshold-based DSR reporting. In such cases, DSR reporting is triggered at the UE 104 when a remaining delay of a PDU or PDU set is below a network-configured DSR threshold. The network-configured DSR threshold may be configured per LCG.

In some examples, the NE 102 considers PDU set delays when scheduling transmissions at the UE 104, e.g., by giving priority to transmissions that are closer to their delay budget than other transmissions, and/or by refraining from scheduling transmissions (e.g., uplink transmissions) that exceed a PSDB. For example, for downlink transmissions, the NE 102 may be aware of a remaining delay budget of data pending for transmission, e.g., based on information provided by the SMF, and may consider the remaining delay budget when making scheduling decisions. Additionally, or alternatively, the UE 115 utilizes PDU set delays to conserve power. For instance, the UE may determine if an uplink transmission (e.g., an uplink pose transmission, a PUSCH transmission) that corresponds to a transmission that exceeds its delay budget can be dropped. The UE further does not wait for re-transmission of a PDSCH that will never occur (e.g., the UE stops any associated retransmission timers).

A PDCP entity refers to an instance of a PDCP layer that handles or is otherwise associated with one or more logical channels or radio bearers (e.g., DRBs). A receiving side of a PDCP entity may also be referred to a PDCP receiving entity, a receiving PDCP entity, or the like. A transmitting side of a PDCP entity may also be referred to as a PDCP transmitting entity, a transmitting PDCP entity, or the like. To manage transmission and reception of PDUs according to XR service requirements, a transmitting PDCP entity and a receiving PDCP entity each maintain respective timers based on a PSDB configured for a QoS flow. For example, the transmitting PDCP entity maintains one or more PDCP discard timers initiated upon reception of a PDU and/or SDU from an upper layer. The receiving PDCP entity maintains a reordering timer (e.g., t-reordering) to detect gaps of PDUs and/or SDUs in the reception window and to ensure in-sequence delivery to higher layers.

The receiving PDCP entity maintains and updates a reception window for receiving PDUs and/or SDUs. The reception window has a defined size and range of SNs. When the receiving PDCP entity receives PDUs and/or SDUs, the receiving PDCP entity checks the SNs and/or COUNT value of the PDUs and/or SDUs. If the COUNT of a PDU and/or SDU is the next expected SN according to the reception window, the PDU and/or SDU is considered in-sequence, and the receiving PDCP entity updates the lower edge of the reception window to the next expected sequence number. The receiving PDCP entity then immediately delivers the PDU and/or SDU to upper layers. However, if a PDU and/or SDU arrives out of sequence (e.g., its COUNT is higher than expected), the receiving PDCP entity triggers timer t-reordering. The receiving PDCP entity temporarily stores out-of-sequence PDUs and/or SDUs in a reception buffer until the expected PDU and/or SDU (filling the gap in the reception buffer) arrive or timer t-reordering expires. The timer t-reordering runs for a predefined duration, allowing time for the missing PDU(s) and/or SDU(s) to arrive. During the timer duration, the receiving PDCP entity continues to receive and buffer PDUs and/or SDUs. If the missing PDU and/or SDU arrives within this duration, the buffered PDUs and/or SDUs are reordered and delivered in sequence to upper layers. If t-reordering expires and the missing PDU and/or SDU has not arrived, the receiving PDCP entity assumes that the missing PDU and/or SDU is lost. The receiving PDCP entity then delivers the buffered PDUs and/or SDUs to upper layers in the order they were received, excluding the missing PDU and/or SDU.

The transmitting PDCP entity and the receiving PDCP entity each maintain a set of one or more state variables (e.g., TX_NEXT, RX_NEXT, RX_DELIV, RX_REORD). Some state variables (e.g., TX_NEXT, RX_NEXT, RX_DELIV) have an initial value set to 0 and are incremented by the responsible PDCP entity as transmission and reception occurs. TX_NEXT is be maintained by the transmitting PDCP entity and indicates a COUNT value of a next PDCP SDU to be transmitted. The receiving PDCP entity maintains RX_NEXT, RX_DELIV, and RX_REORD. RX_NEXT indicates the COUNT value of the next PDCP SDU expected to be received at the receiving PDCP entity. RX_DELIV indicates the COUNT value of the first PDCP SDU not delivered to upper layers, but that the receiving PDCP entity is still waiting to receive. RX_REORD indicates the COUNT value following the COUNT value associated with a PDCP data PDU that triggered a reordering procedure at the receiving PDCP entity (e.g., that triggered initiation of timer t-reordering).

As an example, at reception of a PDCP SDU from upper layers, the transmitting PDCP entity starts a discard timer associated with this PDCP SDU. The transmitting PDCP entity associates the COUNT value corresponding to TX_NEXT to this PDCP SDU. At reception of a PDCP data PDU from lower layers, the receiving PDCP entity determines the COUNT value of the received PDCP Data PDU, i.e., RX_COUNT. When timer t-reordering expires, the receiving PDCP entity delivers, to upper layers in ascending order of the associated COUNT value after performing header decompression (e.g., if not decompressed before): all stored PDCP SDU(s) with associated COUNT value(s) less than RX_REORD; and all stored PDCP SDU(s) with consecutively associated COUNT value(s) starting from RX_REORD. The receiving PDCP entity updates RX_DELIV to the COUNT value of the first PDCP SDU which has not been delivered to upper layers, with COUNT value greater than or equal to RX_REORD. The receiving PDCP entity updates RX_REORD to RX_NEXT and start timer t-reordering if RX_DELIV is less than RX_NEXT.

One or two PDCP discard timers are configured for each DRB or PDCP entity. A time duration of a PDCP discard timer reflects QOS requirements of packets belonging to a service. That is, the time duration may represent a delay budget in that the time duration corresponds to a time allowed for a transmitting PDCP entity to transmit PDUs and/or SDUs belonging to a PDU set. Accordingly, when the PDCP discard timer expires, the delay budget has been exceeded, and the corresponding PDU and/or SDU should be discarded by the transmitting PDCP entity. As an example, upon reception of a PDCP SDU from an upper layer, the transmitting PDCP entity starts the PDCP discard timer associated with the PDCP SDU. When the PDCP discard timer associated with a PDCP SDU expires, or when the successful delivery of a PDCP SDU is confirmed by a PDCP status report, the transmitting PDCP entity discards the PDCP SDU. The PDCP discard timer may be configured in the range of 0.5 ms to 1500 ms or can be switched off by choosing infinity.

Another PDU set discard mechanism is based on an importance level (e.g., PSI) of a PDU set (referred to herein as PSI-based discarding), e.g., in addition to a timer-based discard mechanism within a given PDCP entity. The CN 106 may control PSI-based discarding mechanisms in the presence of traffic congestion. For example, the CN 106 detects congestion at the UE 104 and explicitly instructs the UE 104 to enable or disable PSI-based discarding based on the congestion. In conventional PSI-based discarding, a transmitting UE 104 may be configured with two PDCP discard timers (e.g., discardTimer and discardTimerForLowImportance). If the CN 106 enables PSI-based discarding (e.g., in the event of a detected congestion), the UE 104 (e.g., a PDCP entity of the UE 104) applies the discard timer discardTimerForLowImportance for low importance PDU sets. More specifically, the UE 104 determines that a given PDU set is a low-importance PDU set and, upon reception of an SDU belonging to the low-importance PDU set, the UE 104 initiates the discard timer discardTimerForLowImportance. However, conventional PSI-based discarding does not provide handling of higher importance PDU sets as described in the present disclosure.

In some examples, the CN 106 configures a UE 104 to enable or disable triggering of DSR, for example, based on a DSR threshold configured by the CN 106. One DSR thresholds may be configured per LCG. The DSR threshold is a remaining delay threshold configured by the CN 106, such that the UE 104 is triggered to initiate DSR when a remaining delay of a PDU and/or SDU of a PDU set is below the DSR threshold. The remaining delay (also referred to as a remaining time) is defined as a time duration remaining until a corresponding discard timer expires. The UE 104 transmits the DSR as part of a MAC-CE. In some scenarios, when the UE 104 triggers DSR for an LCG, the UE 104 may also report a buffer status associated with the remaining delay. In some examples, a single MAC-CE is defined for the DSR including the buffer status. The MAC-CE indicating the DSR, e.g., the DSR MAC-CE, is separate from (e.g., not coupled with) a buffer status report (BSR) MAC-CE and indicates a remaining delay and an associated data volume. The data volume may be an amount of data available for transmission, e.g., in a PDCP entity and/or RLC entity of the UE 104.

The data volume may include information about delay-critical traffic. A delay-critical RLC SDU may be defined as an RLC SDU corresponding to a PDCP PDU that is indicated as delay-critical by the PDCP entity. For DSR via MAC-CE, the UE 104 may include, as the indicated data volume, delay-critical RLC SDUs and delay-critical RLC SDU segments that have not yet been included in an RLC data PDU, RLC data PDUs pending for initial transmission and containing a delay-critical RLC SDU or a delay-critical RLC SDU segment, and/or RLC data PDUs that are pending for retransmission (e.g., RLC acknowledge mode (AM)).

A delay-critical PDCP SDU may be defined according to whether the PDCP entity (e.g., a transmitting PDCP entity) is configured to discard PDU sets. When pdu-SetDiscard is not configured at the PDCP entity, for example, a delay-critical PDCP SDU is defined as a PDCP SDU for which a remaining time (e.g., until an associated discard timer expires) is less than a configured remaining time threshold (e.g., remainingTimeThreshold). Alternatively, if pdu-SetDiscard is configured at the PDCP entity, a delay-critical PDCP SDU is defined as a PDCP SDU belonging to a PDU set of which at least one PDCP SDU has a remaining time less than the configured remaining time threshold. If a PDCP SDU becomes a delay-critical PDCP SDU, and if the corresponding PDCP data PDU has already been submitted to lower layers, the delay-critical indication for the PDCP data PDU may be provided to the lower layers. For DSR via MAC-CE, the UE 104 may include, as the indicated data volume, delay-critical PDCP SDUs for which no PDCP data PDUs have been constructed, PDCP data PDUs that contain the delay-critical PDCP SDUs and have not been submitted to lower layers, PDCP control PDUs, PDCP SDUs to be retransmitted (e.g., for AM DRBs), and/or PDCP data PDUs to be retransmitted (e.g., for AM DRBs).

When a PDCP status report confirms successful delivery of a PDCP SDU, a transmitting PDCP entity discards the PDCP SDU along with the corresponding PDCP data PDU. If, however, the PDCP SDU has not been confirmed as successfully delivered, the transmitting PDCP entity may take different actions based on whether the transmitting PDCP entity is configured to discard PDU sets. When pdu-SetDiscard is configured, for example, the transmitting PDCP entity discards all PDCP SDUs belonging to the PDU set to which the PDCP SDU belongs, along with any corresponding PDCP data PDUs. PDCP SDUs subsequently received from upper layers may also be discarded if they belong to the PDU set. Alternatively, if pdu-SetDiscard is not configured, the transmitting PDCP entity discards the PDCP SDU along with the corresponding PDCP data PDU.

The techniques described herein support additional PDCP discard timers corresponding to PDU importance levels (e.g., priority levels, PSIs), such as a discardTimerForHighImportance configured for high-importance PDU sets. For example, an NE 102 configures, for a PDCP entity (e.g., a transmitting PDCP entity associated with a UE 104), a mapping between a set of timer configurations and a set of priority levels. The set of timer configurations may, in some examples, be configured per DRB for XR traffic between the UE 104 and the NE 102 and/or CN 106. Each timer configuration of the set of timer configurations corresponds to a respective timer, such as a discard timer (e.g., a PDCP discard timer), and indicates one or more parameters for the timer, such as a time duration. The priority levels may be priority levels associated with XR traffic, e.g., PDUs, PDU sets, SDUs, ADUs, or the like.

The NE 102 transmits, to the UE 104, a PDCP configuration message indicating the set of timer configurations corresponding to the set of priority levels. The PDCP entity receives, from a higher layer, at least one SDU (e.g., PDCP SDU) for transmission (e.g., to the CN 106 and/or the NE 102). The SDU is associated with a priority level of the set of priority levels and a radio bearer and/or QoS flow. The UE 104 selects a timer configuration from the set of timer configurations that corresponds to the priority level associated with the SDU. The UE 104 initiates a timer corresponding to the selected timer configuration and having a time duration indicated by the selected timer configuration. The UE 104 runs the timer until successful delivery of the SDU is confirmed (e.g., by PDCP status report) or until the timer expires. In the latter case, the UE 104 discards the SDU.

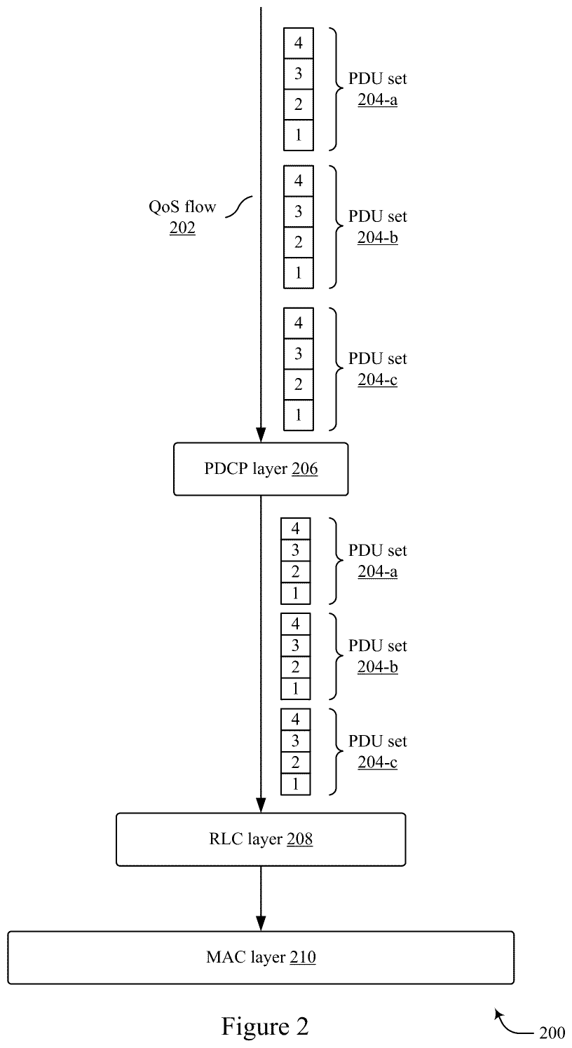

FIG. 2 illustrates an example protocol stack 200 in accordance with aspects of the present disclosure. The protocol stack 200 may implement or be implemented by aspects of the wireless communications system 100 as described with reference to FIG. 1. For example, the protocol stack 200 may be implemented by a wireless device such as a UE 104. The protocol stack 200 is associated with a QoS flow 202 to which PDU sets 204 are mapped. The QoS flow 202 is configured with a PSDB and a PSER. The protocol stack 200 includes a PDCP layer 206, an RLC layer 208, and a MAC layer 210.

In the example of FIG. 2, a PDCP entity associated with the PDCP layer 206 receives, from an upper layer, a PDU set 204-a, a PDU set 204-b, and a PDU set 204-c. Each PDU set 204 includes a quantity of SDUs and/or PDUs identified by a respective SN indicated in the SDU or PDU's header, e.g., according to the SDU or PDU's ordered position within the PDU set 204. The SN is used at a receiving PDCP entity to reorder SDUs and/or PDUs received out of order. The PDU sets 204 carry data (e.g., SDUs) for XR services and applications and each PDU set 204 is associated with an importance level (e.g., a priority level, a PSI level). For instance, the PDU sets 204 may carry video frames, such as I-frames and P-frames, of a video stream, where I-frames are associated with a relatively high importance level and P-frames are associated with a relatively low importance level.

A PDU and/or a PDU set, such as a PDU set 204, includes a header (e.g., a GTP-U header) indicating information about the PDU set 204 (e.g., PDU set information), such as the importance level, a PDU set ID, a PDU set size, or the like. The importance level may be indicated as a PSI level and/or a priority level. Additionally, or alternatively, the importance level may be indicated by a field in the PDU set information that indicates whether a PDU set or SDU is used as a reference for decoding other (e.g., dependent) PDU sets and/or SDUs. For instance, the field indicated that the PDU set 204-c is used as a reference for decoding a dependent PDU set 204, such as the PDU set 204-b. The UE 104 can determine, based on the indication, that the PDU set 204-c is associated with a relatively high importance level.

The UE 104 received a configuration message (e.g., a control message, such as a radio resource control (RRC) message) for the PDCP entity that indicates one or more PDCP configuration parameters. For example, the configuration message indicated a set of timer configurations (e.g., PDCP timer configurations) corresponding to a set of priority levels associated with PDU sets. In some cases, the configuration message indicated a mapping between the set of timer configurations and the set of priority levels. In some examples, the set of timer configurations is configured for the PDCP entity regardless of whether PSI-based discarding is enabled or disabled. Alternatively, the set of timer configurations is configured for the PDCP entity only when PSI-based discarding is disabled.

In implementations, each priority level of the set of priority levels corresponds to a PSI. Additionally, or alternatively, the priority levels represent whether a PDU and/or SDU belonging to a PDU set 204 is used as a reference for other PDUs and/or SDUs belonging to other PDU sets 204, e.g., whether the other PDUs and/or SDUs belonging to other PDU sets 204 depend on the PDU and/or SDU belonging to the PDU set 204 for decoding. In the example of FIG. 2, the PDU set 204-c may be an example of an I-frame and the PDU sets 204-b and 204-a may be examples of P-frames. Thus, the PDU set 204-c may be used (e.g., by a receiving device) to decode the PDU sets 204-b and 204-a and, as such, the PDU set 204-c is associated with a relatively high priority level. The PDU sets 204-b and 204-a may each be associated with a relatively low priority level.

Each timer configuration indicates a time duration for a timer, such as a PDCP discard timer, where the time duration is based on the corresponding priority level of the set of priority levels. For example, a first timer configuration corresponds to a highest priority level and indicates a first time duration for a first timer for high-importance PDU sets (e.g., discardTimerForHighImportance), such as the PDU set 204-c. A second timer configuration corresponds to a neutral priority level and indicates a second time duration for a second timer for neutral priority PDU sets. The second time duration is less than the first time duration, such that higher priority level PDU sets are provided with additional time to be transmitted by the PDCP entity. A third timer configuration corresponds to a lowest priority level and indicates a third time duration for a third timer for low-priority PDU sets (e.g., discardTimerForLowImportance). The third time duration is less than the second time duration (e.g., lower priority PDU sets are given less time to be transmitted by the PDCP entity than neutral priority PDU sets or higher priority PDU sets).

Upon reception of a PDU and/or SDU belonging to a PDU set 204, the UE 104 determines an importance level associated with the PDU and/or SDU, e.g., by determining the importance level associated with the PDU set 204. In some examples, the UE 104 determines the importance level of the PDU set 204 based on whether the PDU set 204 is a reference for other PDU sets 204 with respect to decoding. In other examples, the UE 104 determines the importance level of the PDU set 204 from associated PDU header information. The UE 104 selects, from the set of timer configurations, the timer configuration corresponding to the determined importance level (e.g., according to the mapping). In some cases, the UE 104 selects the timer configuration based on whether PSI-based discarding is enabled or disabled. For instance, the UE 104 may select the timer configuration only if PSI-based discarding is disabled. The PDCP entity then initiates a timer having a time duration indicated by the selected timer configuration.

As a specific, non-limiting example, the UE 104 receives an SDU of the PDU set 204-c at the PDCP layer 206. The UE 104 determines that the PDU set 204-c is used as a reference for PDU sets 204-a and 204-b, and thus further determines that the SDU has a high priority level. Accordingly, the UE 104 select the first timer configuration. The PDCP entity initiates the first timer discardTimerForHighImportance. In some cases, the PDCP entity delivers the SDU to a lower layer (e.g., the RLC layer 208, the MAC layer 210) prior to expiry of the first timer, after which the UE 104 transmits the SDU. The PDCP entity may discard the SDU after expiry of the first timer.

In some examples, the second timer configuration corresponds to a legacy PDCP discard timer configuration (e.g., discardTimer) and the second time duration is based on the PSDB for the QoS flow 202. In such examples, the first time duration is greater than the PSDB. That is, by utilizing discardTimerForHighImportance in transmission of the PDU set 204-c, the PDCP entity transmits PDUs and/or SDUs of the PDU set 204-c even if the PSDB has been exceeded, thereby avoiding discarding of the PDU set 204-c needed to decode the PDU sets 204-a and 204-b.

In implementations, for high-priority SDUs, the UE 104 implements the first timer configuration in addition to the second timer configuration. For instance, upon reception of an SDU of the PDU set 204-c at the PDCP layer 206, the PDCP entity starts timer discardTimer (e.g., the legacy PDCP discard timer). Upon expiry of discardTimer, the PDCP entity then starts a second timer, e.g., discardTimerForHighImportance. In some cases, the PDCP entity starts timer discardTimerForHighImportance after expiration of discardTimer only in scenarios in which the SDU has not yet been delivered to a lower layer (e.g., the MAC layer 210) for transmission by the UE 104. That is, the PDCP entity starts discardTimerForHighImportance after expiry of discardTimer prior to delivery of the SDU to the lower layer.

The configuration message may indicate a set of importance levels (e.g., PSI levels) for which the PDCP entity is to start timer discardTimerForHighImportance in addition to timer discardTimer (e.g., upon expiry of the legacy PDCP discardTimer). Alternatively, the UE 104 may determine the set of importance levels for which the PDCP entity is to apply both discardTimerForHighImportance and discardTimer. In implementations, the PDCP entity (e.g., as a transmitting PDCP entity) indicates, to a receiving PDCP entity within a PDCP control PDU (e.g., a PDCP SN gap control PDU), PDUs and/or SDUs belonging to high priority PDU sets 204 as discarded upon expiry of discardTimerForHighImportance, instead of upon expiry of discardTimer (e.g., the legacy PDCP discard timer).

In some examples, the UE 104 is configured with a DSR threshold, based on which the UE 104 is to trigger DSR transmission for an SDU and/or PDU set 204. The DSR threshold may be configured based on expiration of an associated discard timer for the SDU and/or PDU set 204. To ensure that DSR is not triggered at a later point, e.g., due to a greater timer duration, such as associated with the timer discardTimerForHighImportance, the configuration message may indicate a respective DSR threshold associated with each timer configuration of the set of timer configurations. In such cases, each DSR threshold corresponds to a respective time duration of the associated timer configuration. For instance, a DSR threshold corresponding to timer discardTimerForHighImportance is greater than a DSR threshold corresponding to timer discardTimer.

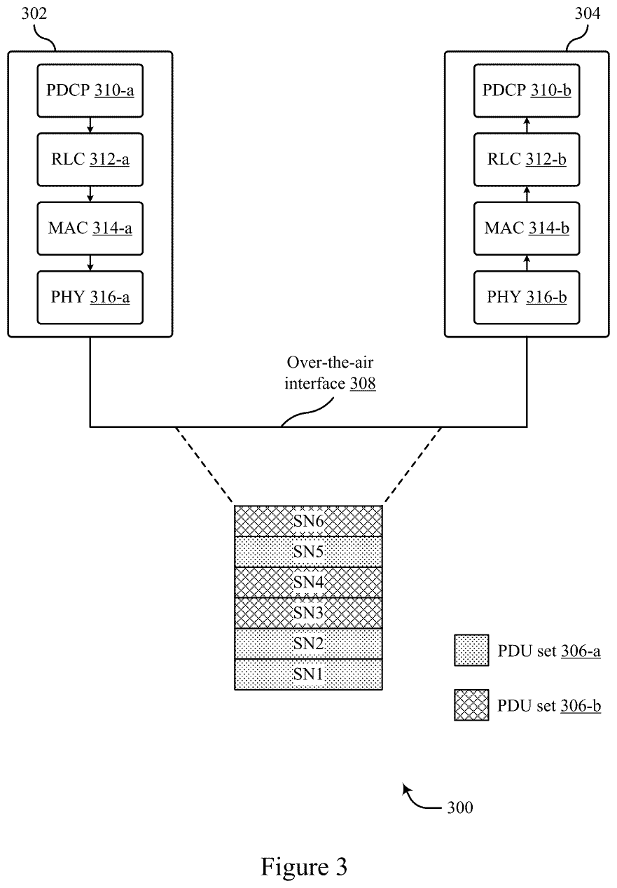

FIG. 3 illustrates an example user plane protocol stack 300 in accordance with aspects of the present disclosure. The user plane protocol stack 300 may implement or be implemented by aspects of the wireless communications system 100 as described with reference to FIG. 1. For example, the user plane protocol stack 300 includes a transmitting device 302 and a receiving device 304, which each may include or be examples of a UE 104 and/or an NE 102. The receiving device 304 and the transmitting device 304 communicate XR traffic, such as PDU sets 306, via an over-the-air interface 308. The receiving device 302 includes a PDCP 310-a, an RLC 312-a, a MAC 314-a, and a PHY 316-a. The transmitting device includes a PDCP 310-b, an RLC 312-b, a MAC 314-b, and a PHY 316-b. The PDU sets 306 are mapped to a QoS flow configured with a PSDB and a PSER.

XR traffic, such as the PDU sets 306, is generated at an application layer of the transmitting device 302 and delivered to the PDCP 310-a. The PDU set 306-a includes three PDUs, each associated with a respective SN, e.g., SN1, SN2, and SN5. The PDU set 306-b also includes three PDUs, e.g., SN3, SN 4, and SN6. The PDU sets 306 are then delivered to the RLC 312-a, the MAC 314-a, and finally to the PHY 316-a for transmission via the over-the-air interface 308. The receiving device 304 receives the PDU sets 306 at the PHY 316-b, from which the PDU sets 306 are delivered to the MAC 314-b, the RLC 312-b, and finally the PDCP 310-b.

In some examples, e.g., due to jitter, PDUs and/or SDUs of the PDU sets 306 may be delivered out of sequence. As illustrated in FIG. 2, PDUs of the PDU set 306-a are interleaved with PDUs of the PDU set 306-b when delivered to the PDCP 310-a at the transmitting device 302. To ensure that the PDU sets 306 are transmitted within their associated PSDB, an RLC entity, such as the RLC 312-a of the transmitting device 302, may prioritize transmission of delay-critical PDUs (e.g., PDUs belonging to a PDU set 306 for which a remaining time is close to zero) over non-delay-critical PDUs. This procedure may be referred to as RLC prioritization. In the example of FIG. 3, the PDU set 306-a may have a remaining time close to zero. The RLC 312-a therefore prioritizes delivery, to the MAC 314-a, of SN5 of the PDU set 306-a over SN3 and SN4 of the PDU set 306-b in order to ensure that the PDU set 306-a is transmitted by the transmitting device 302 and received by the receiving device 304 within the PSDB.

However, RLC prioritization in such scenarios (e.g., when PDUs of PDU sets 306 are interleaved upon delivery to the PDCP 310-a) results in changing a transmission order (e.g., an SN order) of the PDUs at the transmitting device. Transmitting PDUs out of order in this manner triggers reordering at a PDCP entity of the receiving device 304 (e.g., the PDCP 310-b), as the PDUs are received out of order at the receiving device 304, causing a gap in a reception window associated with the PDUs. For example, upon reception of one or more out-of-sequence PDUs (e.g., upon receiving SN5 before SN3 or SN4), the PDCP 310-b starts a timer t-reordering and waits the duration of the timer to receive the remaining PDUs (e.g., SN3 and SN4). The reordering operation at the receiving device 304 delays delivery of a delay-critical PDU (e.g., SN5) to higher layers, as the PDCP 310-b refrains from delivering out-of-order PDUs to a higher layer until expiry of the timer. As a result, meeting the PSDB is no longer possible.

In implementations of the techniques described herein, the receiving device 304 disables PDCP reordering for the PDCP 310-b when delay-based RLC prioritization is enabled for an associated RLC bearer (e.g., the corresponding RLC 312-a) or LCH. Accordingly, when the RLC 312-a sends PDUs out of order due to prioritization of delay-critical PDUs, the PDCP 310-b refrains from performing reordering. Instead, the PDCP 310-b immediately delivers the out-of-order PDUs to higher layers.

Additionally, or alternatively, a network refrains from configuring PDCP reordering procedures for the PDCP 310-b (e.g., a receiving PDCP entity) when delay-based RLC prioritization is enabled at the RLC 312-a (e.g., a transmitting RLC entity). For example, the network configures, for the RLC 312-a, whether the RLC 312-a should prioritize transmission of delay-critical PDUs, e.g., whether the RLC 312-a should deliver delay-critical PDUs to the MAC 314-a before non-delay-critical PDUs even if this results in out-of-order transmission of the PDUs. When the network configures the RLC 312-a to enable delay-based RLC prioritization, the network may also configure the PDCP 310-b to disable PDCP reordering (e.g., the network configures outOfOrderDelivery for the PDCP 310-b), such that PDUs received by the PDCP 310-b are delivered to upper layers without delays associated with PDCP reordering. Alternatively, when the network configures the RLC 312-a to disable delay-based RLC prioritization, the network may also configure the PDCP 310-b to enable PDCP reordering.

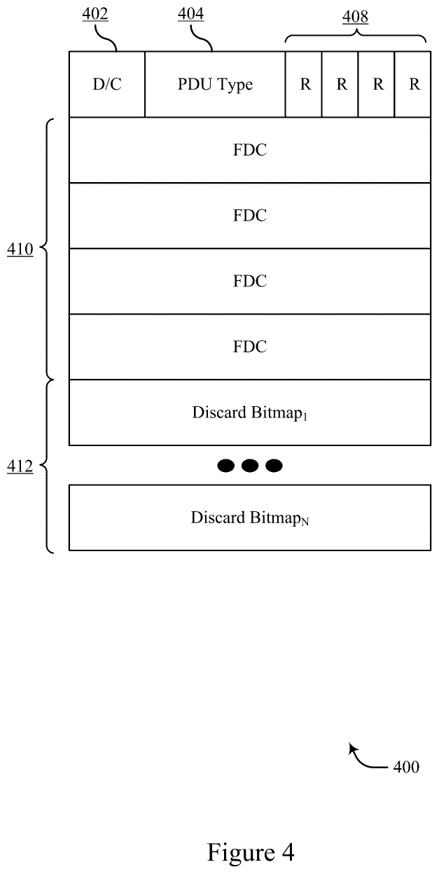

In implementations, and as described with reference to FIG. 4, one or more PDUs are delivered to a higher layer even when the one or more PDUs are received after expiry of the PSDB and outside of a corresponding PDCP reception window (e.g., the one or more PDUs are received after the PDCP reception window has been moved forward). For instance, a relatively high priority PDU (e.g., a PDU associated with a relatively high priority PDU set 306) received at the PDCP 310-b outside of a corresponding PDCP reception window is typically discarded by the PDCP 310-b. However, the high priority PDU may be used to decode dependent SDUs and/or PDUs, such that discarding the high priority PDU prevents decoding of the dependent SDUs and/or PDUs and degrades performance. Accordingly, as described herein, the transmitting device 302 communicates information to the receiving device 304 about out-of-order PDUs that should be delivered (e.g., immediately) to higher layers even if the PSDB has been exceeded.

For example, a field within a PDCP header of the PDU set 306-b indicates that the PDU set 306-b is associated with a relatively high priority. Additionally, the field indicates whether a corresponding PDU and/or SDU of the PDU set 306-b should be delivered to a higher layer after expiry of the PSDB (e.g., even if the PDU and/or SDU is delivered outside of the PDCP reception window). Upon reception of the PDU and/or SDU by the PDCP 310-b, the PDCP 310-b determines whether RX_COUNT is less than RX_DELIV. If so, the PDCP 310-b has received the PDU and/or SDU outside of the reception window. The PDCP 310-b then delivers the PDU and/or SDU to a higher layer based on the indication in the PDCP header.

FIG. 4 illustrates an example PDCP control PDU 400 in accordance with aspects of the present disclosure. The PDCP control PDU 400 may implement or be implemented by aspects of the wireless communications system 100. For example, the PDCP control PDU 400 may be transmitted and/or received by a UE 104 and/or an NE 102 and may correspond to a PDU set. The PDCP control PDU 400 includes a D/C field 402, a PDU Type field 404, a set of reserved bit fields 408, a set of first discarded COUNT (FDC) fields 410, and a set of discard bitmaps 412. The D/C field 402 is one bit in length and indicates whether the PDCP control PDU 400 is a PDCP data PDU or a PDCP control PDU. The PDU Type field 404 has a length of 3 bits and indicates a type of control information included in the PDCP control PDU 400. The reserved bit fields 408 are each one bit in length.

According to the techniques described herein, a transmitting PDCP entity provides, to its corresponding receiving PDCP entity, information (e.g., control information) about PDCP SDUs associated with a PDU set that is close to its PSDB, where the PDCP SDUs should be delivered by the receiving PDCP entity to a higher layer regardless of whether there are gaps between the indicated PDCP SDUs in the reception window. A gap between SDUs in the reception window indicates that one or more SDUs have been missed or have not yet been received by the receiving PDCP entity, resulting in out-of-order delivery of the indicated SDUs. The control information may include or be an example of the PDCP control PDU 400. In implementations, the transmitting PDCP entity indicates, to the receiving PDCP entity as part of the PDCP control PDU 400, one or more SNs identifying one or more PDCP SDUs that should be delivered, to upper layers, immediately upon reception by the receiving PDCP entity. Additionally, or alternatively, the PDCP control PDU 400 indicates a COUNT value of the one or more PDCP SDUs to be delivered out-of-order immediately to upper layers.

In some examples, the transmitting PDCP entity triggers transmission of the PDCP control PDU 400 upon submitting PDCP SDUs out-of-order to an RLC layer, which, when received at the receiving PDCP entity, may otherwise trigger a reordering procedure. For instance, when uplink packets (e.g., SDUs) of multiple PDU sets are not received in sequence at a PDCP layer due to jitter, the uplink packets are delivered out-of-order to the RLC layer, based on which the transmitting PDCP entity transmits the PDCP control PDU 400 to the receiving PDCP entity. Additionally, or alternatively, the transmitting PDCP entity triggers transmission of the PDCP control PDU 400 if a corresponding transmitting RLC entity is configured to implement RLC prioritization of delay-critical data, e.g., as described with reference to FIG. 3. In another example, the transmitting RLC entity indicates, to the transmitting PDCP entity, that the transmitting RLC entity delivered RLC PDUs out-of-order to a corresponding MAC layer, e.g., due to prioritization of delay-critical RLC PDUs. Based on receiving such an indication from the transmitting RLC entity, the transmitting PDCP entity initiates transmission of the PDCP control PDU 400 to indicate out-of-order delivery of PDCP SDUs to upper layers.

In implementations, the PDCP control PDU 400 is dedicated for indication of out-of-order delivery and is associated with a corresponding entry in the PDU Type field 404. That is, the PDU Type field 404 indicates that the PDCP control PDU 400 is used to indicate out-of-order delivery information. Alternatively, a PDCP SN gap report control PDU is reused to convey out-of-order delivery indications. In this case, a reserved bit field 408 of the PDCP SN gap report control PDU indicates that the PDCP SN gap report control PDU is used to indicate a COUNT value of a PDU that is to be delivered out-of-order (e.g., without waiting for reordering to take place). Additionally, or alternatively, an FDC field 410 indicates a first COUNT of an SDU and/or PDU that can be delivered out-of-order to a higher layer. In implementations, a discard bitmap 412 indicates subsequent SDUs and/or PDUs that can be delivered out-of-order to a higher layer.

Based on receiving the PDCP control PDU 400, the receiving PDCP entity delivers the indicated one or more PDCP SDUs to the higher layer even when there are gaps in the reception window, e.g., even if the timer t-reordering is running (e.g., prior to expiry of the timer t-reordering). Put another way, the receiving PDCP entity disables (e.g., temporarily) a reordering function for the one or more PDCP SDUs and subsequently delivers the one or more PDCP SDUs to the higher layer out of order, e.g., without first reordering the PDCP SDUs. The receiving PDCP entity therefore delivers PDCP SDUs that are part of a PDU set to the higher layer prior to exceedance of the PSDB associated with the PDU set.

In some cases, the indicated one or more PDCP SDUs are stored in a reception buffer of the receiving PDCP entity and the receiving PDCP entity delivers the one or more PDCP SDUs from the reception buffer to the higher layer. Alternatively, if a PDCP SDU of the one or more PDCP SDUs has not yet been placed in the reception buffer (e.g., the PDCP SDU has not yet been received by the receiving PDCP entity), the receiving PDCP entity stores the indicated COUNT value corresponding to the PDCP SDU. In such cases, the receiving PDCP entity delivers the PDCP SDU corresponding to the indicated COUNT value to the higher layer after the PDCP SDU has been received and placed in the reception buffer.

The present disclosure further provides techniques for updating state variables maintained by a PDCP entity. For instance, in implementations, the receiving PDCP entity does not update state variables immediately upon out-of-order delivery of PDCP SDUs to higher layers, which may ensure that the reception window is updated correctly. That is, if the receiving PDCP entity delivers the one or more PDCP SDUs to higher layers while t-reordering is running, the receiving PDCP entity waits to update the state variables until expiry of t-reordering, e.g., as if the one or more PDCP SDUs had been delivered upon expiry of t-reordering. As a specific example, the receiving PDCP entity updates RX_DELIV upon expiry of t-reordering as if the one or more PDCP SDUs that were delivered out-of-order to an upper layer while t-reordering was running were instead delivered after expiry of t-reordering.

In some examples, a field within a PDCP header indicates whether a corresponding PDCP SDU should be delivered out-of-order to a higher layer. For instance, the field indicates whether, upon successful decoding, the PDCP SDU should be delivered to a higher layer even if there are gaps in the reception window (e.g., even when t-reordering is running). In implementations, a field within an RLC header indicates that the corresponding PDCP SDU should be delivered to a higher layer regardless of whether t-reordering is running. Upon successful decoding of an RLC SDU at an RLC receiving entity and delivering a PDCP SDU to the PDCP entity, the RLC entity indicates, to the receiving PDCP entity, that the corresponding PDCP SDU is to be immediately delivered to a higher layer.

Although the examples of FIG. 4 are discussed with reference to PDCP SDUs, it is to be understood that the examples are non-limiting and may be applied to PDCP PDUs, PDU sets, or combinations thereof.

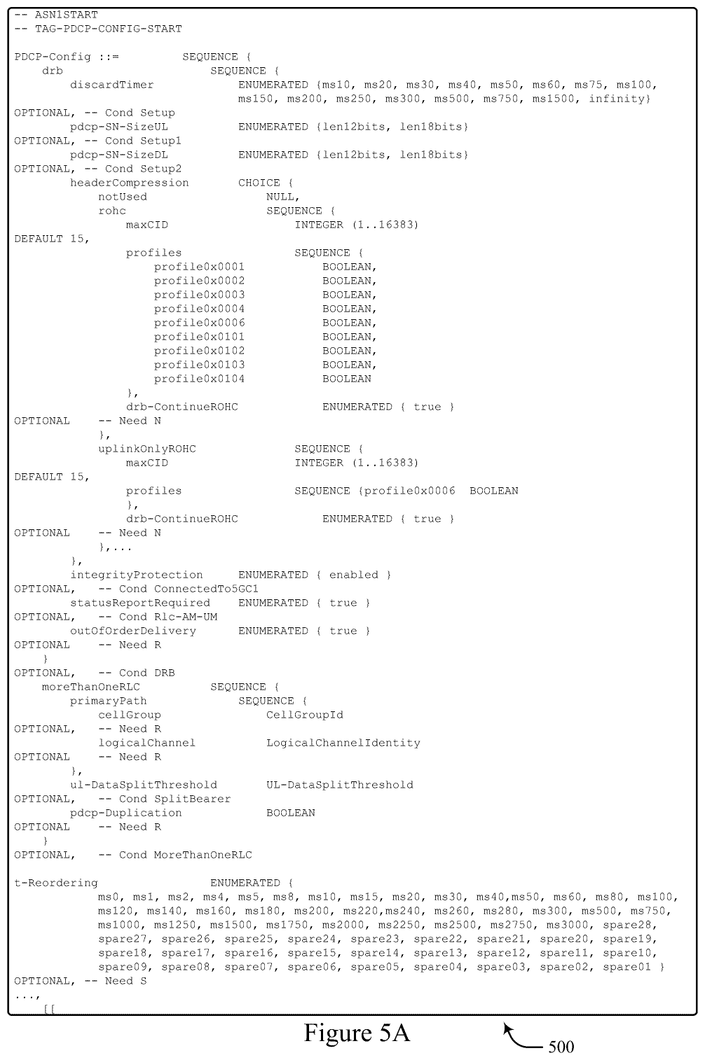

FIGS. 5A and 5B illustrate an example PDCP configuration information element (IE) 500 in accordance with aspects of the present disclosure. The PDCP configuration IE 500 may implement or be implemented by aspects of the wireless communications system 100. For example, the PDCP configuration IE 500 may be included as part of a configuration message transmitted, by an NE 102, to a UE 104 to configure a PDCP entity of the UE 104 as described herein.

The PDCP configuration IE 500 (e.g., PDCP-Config) is used to set configurable PDCP parameters for signaling, multicast and broadcast service (MBS), and data radio bearers. The PDCP configuration IE 500 configures whether outOfOrderDelivery is enabled or disabled at a receiving PDCP entity, and further configures a timer t-reordering for the receiving PDCP entity. Additionally, the PDCP configuration IE 500 indicates whether PDU set discarding is enabled or disabled (e.g., pdu-SetDiscard-r18).

The PDCP configuration IE 500 includes a set of timer configurations (e.g., PDCP discard timer configurations) including discardTimer as illustrated in FIG. 5A and discardTimerForLowImportance-r18 and discardTimerForHighImportance-r19 as illustrated in FIG. 5B. The set of timer configurations indicates a respective time duration in ms for each timer and corresponds to a set of priority levels (e.g., PDU priority levels). According to the techniques described herein, the NE 102 configures the set of timer configurations for the PDCP entity of the UE 104. In implementations, the NE 102 configures a mapping between the set of timer configurations and the set of priority levels. The NE 102 transmits the PDCP configuration IE 500 to the UE 104. Upon reception of a PDU and/or SDU for transmission at the PDCP entity, the UE 104 selects a timer configuration from the set of timer configurations based on a priority level of the PDU and/or SDU. The UE 104 initiates a timer having a time duration indicated by the selected timer configuration. For instance, the UE 104 determines that the PDU and/or SDU is associated with a high priority and selects discardTimerForHighImportance-r19. In some examples, the UE 104 first starts discardTimer and subsequently starts discardTimerForHighImportance-r19 upon expiry of discardTimer.

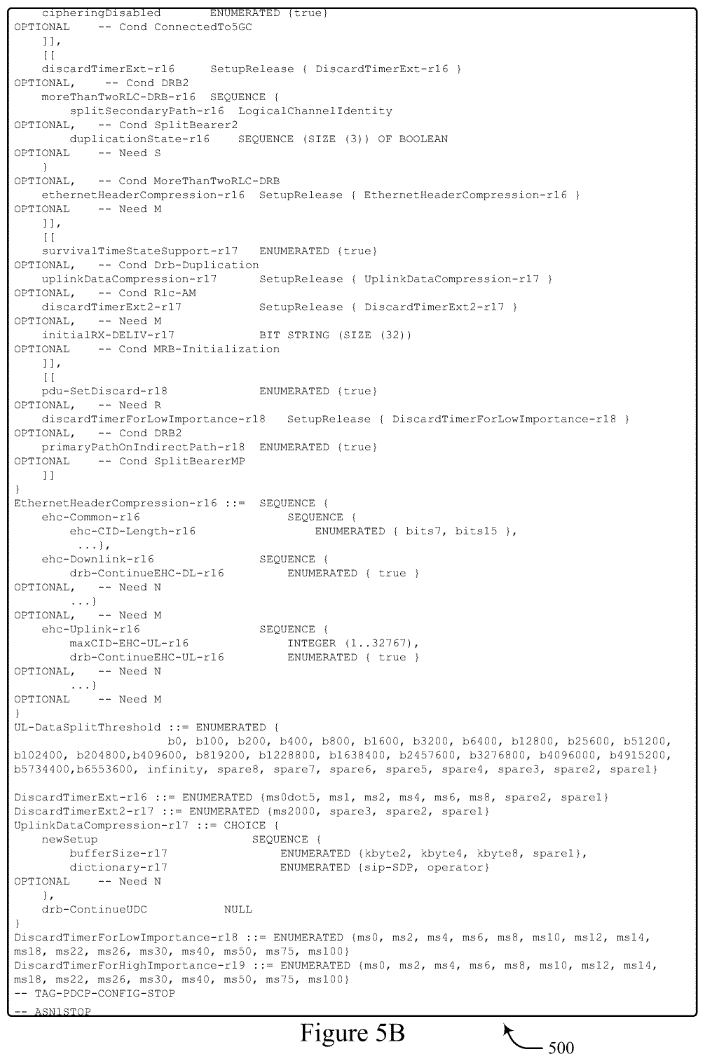

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving, from a radio access network, a configuration message for a PDCP entity of the UE, the configuration message indicating a set of timer configurations corresponding to a set of priority levels; receiving, at the PDCP entity, at least one SDU for transmission, the SDU associated with a radio bearer and a priority level of the set of priority levels; and selecting a timer configuration from the set of timer configurations based at least in part on the priority level associated with the SDU.

Additionally, the UE 600 may be configured to support any one or combination of the method further comprising initiating a timer based at least in part on reception of the SDU associated with the radio bearer, and the timer configuration indicates a timer duration for the timer. The timer may be a PDCP discard timer. The set of timer configurations may include at least a first timer configuration corresponding to a higher priority level of the set of priority levels, a second timer configuration corresponding to a lower priority level of the set of priority levels, and a third timer configuration corresponding to a legacy timer configuration. The first timer configuration may indicate a first timer duration that is greater than a second timer duration associated with the second timer configuration and a third timer duration associated with the third timer configuration. The method of selecting the timer configuration comprises selecting the first timer configuration based at least in part on the SDU being associated with the higher priority level. The method further comprising initiating a first timer associated with the first timer configuration after expiry of a second timer associated with the legacy timer configuration. The method further comprising initiating the first timer prior to delivery of the SDU to a lower layer for the transmission. The method further comprising transmitting the SDU prior to expiry of the first timer. The method further comprising discarding the SDU after expiry of the first timer. The method further comprising determining the priority level associated with the SDU based at least in part on the SDU being a reference for decoding one or more other SDUs. The method further comprising selecting the timer configuration based at least in part on PSI-based discard being enabled or disabled. The configuration message indicates a mapping between the set of timer configurations and the set of priority levels. Each priority level of the set of priority levels corresponds to a respective PSI level. The configuration message indicates a respective delay status report threshold associated with each timer configuration of the set of timer configurations. The method further comprising receiving PDU set information indicating at least one of the priority levels of the set of priority levels, a PSI level associated with the SDU, or whether the SDU is a reference for decoding one or more other SDUs. Indicating, within a PDCP header of the SDU, whether the SDU is to be delivered to an upper layer after expiry of a PDU set delay budget.

Additionally, or alternatively, the UE 600 may support at least one memory (e.g., the memory 604) and at least one processor (e.g., the processor 602) coupled with the at least one memory and configured to cause the UE to receive, from a RAN, a configuration message for a PDCP entity of the UE, the configuration message indicating a set of timer configurations corresponding to a set of priority levels; receive, at the PDCP entity, at least one SDU for transmission, the SDU associated with a radio bearer and a priority level of the set of priority levels; and select a timer configuration from the set of timer configurations based at least in part on the priority level associated with the SDU.

Additionally, the UE 600 may be configured to support any one or combination of the at least one processor is configured to cause the UE to initiate a timer based on reception of the SDU associated with the radio bearer, and the timer configuration may indicate a timer duration for the timer. The timer may be a PDCP discard timer. The set of timer configurations may include at least a first timer configuration corresponding to a higher priority level of the set of priority levels, a second timer configuration corresponding to a lower priority level of the set of priority levels, and a third timer configuration corresponding to a legacy timer configuration. The first timer configuration may indicate a first timer duration that is greater than a second timer duration associated with the second timer configuration and a third timer duration associated with the third timer configuration. To select the timer configuration, the at least one processor is configured to cause the UE to select the first timer configuration based on the SDU being associated with the higher priority level. The at least one processor is configured to cause the UE to initiate a first timer associated with the first timer configuration after expiry of a second timer associated with the legacy timer configuration. The at least one processor is configured to cause the UE to initiate the first timer prior to delivery of the SDU to a lower layer for the transmission. The at least one processor is configured to cause the UE to transmit the SDU prior to expiry of the first timer. The at least one processor is configured to cause the UE to discard the SDU after expiry of the first timer. The at least one processor is configured to cause the UE to determine the priority level associated with the SDU based at least in part on the SDU being a reference for decoding one or more other SDUs. The at least one processor is configured to cause the UE to select the timer configuration based at least in part on PSI-based discard being enabled or disabled. The configuration message may indicate a mapping between the set of timer configurations and the set of priority levels. Each priority level of the set of priority levels may correspond to a respective PSI level. each priority level of the set of priority levels corresponds to a respective PSI level. The configuration message indicates a respective delay status report threshold associated with each timer configuration of the set of timer configurations. The at least one processor is configured to cause the UE to receive PDU set information indicating at least one of the priority levels of the set of priority levels, a PSI level associated with the SDU, or whether the SDU is a reference for decoding one or more other SDUs. The at least one processor is configured to cause the UE to indicate, within a PDCP header of the SDU, whether the SDU is to be delivered to an upper layer after expiry of a PDU set delay budget.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

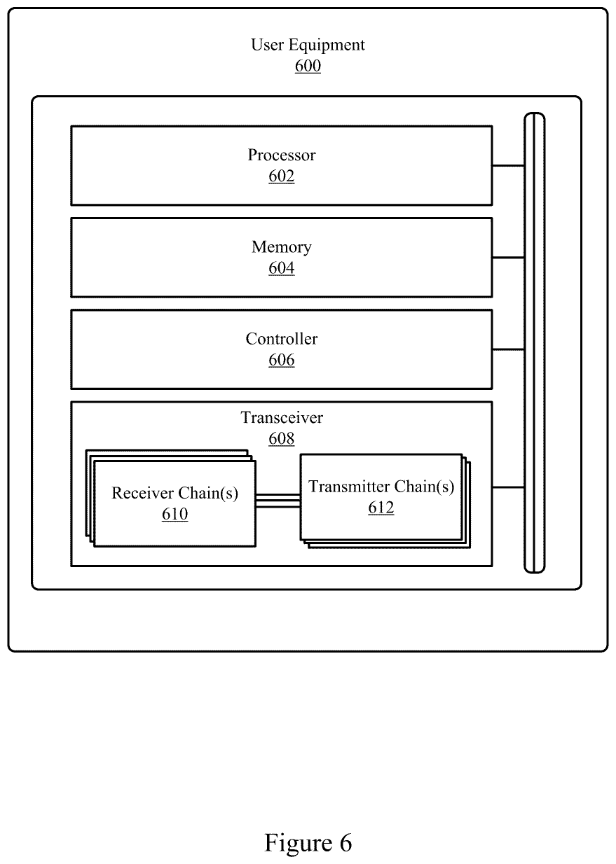

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a radio access network, a configuration message for a PDCP entity associated with the processor, the configuration message indicating a set of timer configurations corresponding to a set of priority levels; receive, at the PDCP entity, at least one SDU for transmission, the SDU associated with a radio bearer and a priority level of the set of priority levels; and select a timer configuration from the set of timer configurations based at least in part on the priority level associated with the SDU.

Additionally, the processor 700 may be configured to or operable to support any one or combination of the at least one controller is configured to cause the processor to initiate a timer based on reception of the SDU associated with the radio bearer, and the timer configuration may indicate a timer duration for the timer. The timer may be a PDCP discard timer. The set of timer configurations may include at least a first timer configuration corresponding to a higher priority level of the set of priority levels, a second timer configuration corresponding to a lower priority level of the set of priority levels, and a third timer configuration corresponding to a legacy timer configuration. The first timer configuration may indicate a first timer duration that is greater than a second timer duration associated with the second timer configuration and a third timer duration associated with the third timer configuration. To select the timer configuration, the at least one controller is configured to cause the processor to select the first timer configuration based on the SDU being associated with the higher priority level. The at least one controller is configured to cause the processor to initiate a first timer associated with the first timer configuration after expiry of a second timer associated with the legacy timer configuration. The at least one controller is configured to cause the processor to initiate the first timer prior to delivery of the SDU to a lower layer for the transmission. The at least one controller is configured to cause the processor to transmit the SDU prior to expiry of the first timer. The at least one controller is configured to cause the processor to discard the SDU after expiry of the first timer. at least one controller is configured to cause the processor to determine the priority level associated with the SDU based at least in part on the SDU being a reference for decoding one or more other SDUs. The at least one controller is configured to cause the processor to select the timer configuration based at least in part on PSI-based discard being enabled or disabled. The configuration message may indicate a mapping between the set of timer configurations and the set of priority levels. Each priority level of the set of priority levels may correspond to a respective PSI level. each priority level of the set of priority levels corresponds to a respective PSI level. The configuration message indicates a respective delay status report threshold associated with each timer configuration of the set of timer configurations. The at least one controller is configured to cause the processor to receive PDU set information indicating at least one of the priority levels of the set of priority levels, a PSI level associated with the SDU, or whether the SDU is a reference for decoding one or more other SDUs. The at least one controller is configured to cause the processor to indicate, within a PDCP header of the SDU, whether the SDU is to be delivered to an upper layer after expiry of a PDU set delay budget.

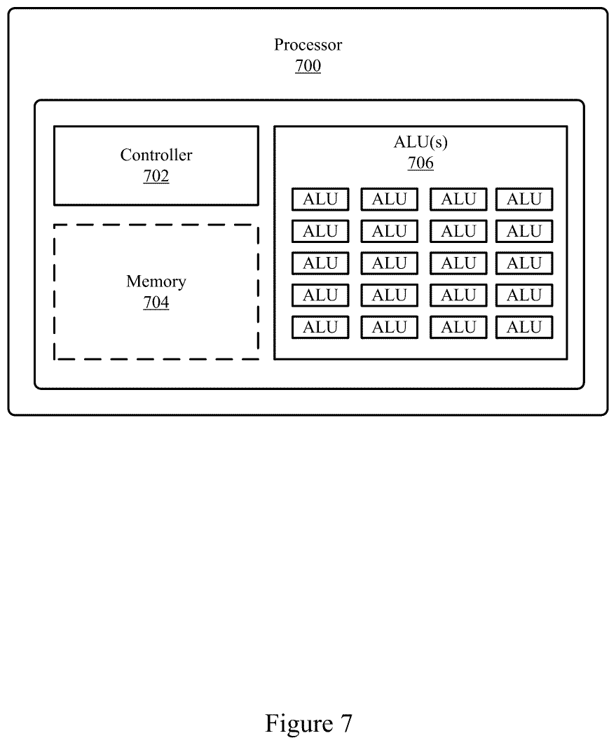

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for configuring, for a PDCP entity of a UE, a mapping between a set of timer configurations and a set of priority levels; and transmitting, to the UE, a configuration message indicating the set of timer configurations corresponding to the set of priority levels.

Additionally, the NE 800 may be configured to or operable to support any one or combination of the timer is a PDCP discard timer. The set of timer configurations includes at least a first timer configuration corresponding to a higher priority level of the set of priority levels, a second timer configuration corresponding to a lower priority level of the set of priority levels, and a third timer configuration corresponding to a legacy timer configuration. The first timer configuration indicates a first timer duration that is greater than a second timer duration associated with the second timer configuration and a third timer duration associated with the third timer configuration. The configuration message indicates a mapping between the set of timer configurations and the set of priority levels. Each priority level of the set of priority levels corresponds to a respective PSI level. The configuration message indicates a respective delay status report threshold associated with each timer configuration of the set of timer configurations.

Additionally, or alternatively, the NE 800 may support at least one memory (e.g., the memory 804) and at least one processor (e.g., the processor 802) coupled with the at least one memory and configured to cause the NE to configure, for a PDCP entity of a UE, a mapping between a set of timer configurations and a set of priority levels; and transmit, to the UE, a configuration message indicating the set of timer configurations corresponding to the set of priority levels.

Additionally, the NE 800 may be configured to support any one or combination of the timer is a PDCP discard timer. The set of timer configurations includes at least a first timer configuration corresponding to a higher priority level of the set of priority levels, a second timer configuration corresponding to a lower priority level of the set of priority levels, and a third timer configuration corresponding to a legacy timer configuration. The first timer configuration indicates a first timer duration that is greater than a second timer duration associated with the second timer configuration and a third timer duration associated with the third timer configuration. The configuration message indicates a mapping between the set of timer configurations and the set of priority levels. Each priority level of the set of priority levels corresponds to a respective PSI level. The configuration message indicates a respective delay status report threshold associated with each timer configuration of the set of timer configurations.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

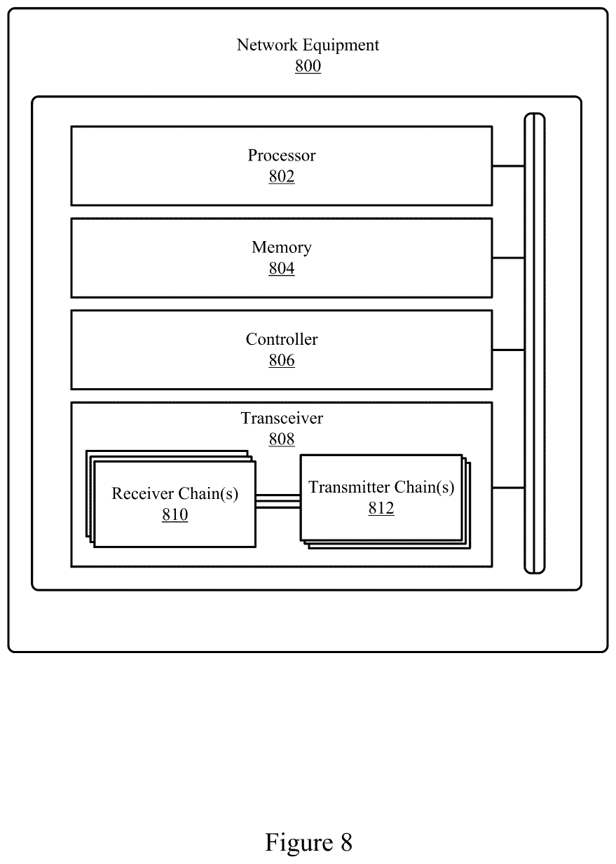

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving, from a radio access network, a configuration message for a PDCP entity of the UE, the configuration message indicating a set of timer configurations corresponding to a set of priority levels. The operations of 902 may be performed in accordance with examples as described herein. In some implementations, aspects of the operations of 902 may be performed by a UE as described with reference to FIG. 6.

At 904, the method may include receiving, at the PDCP entity, at least one SDU for transmission, the SDU associated with a radio bearer and a priority level of the set of priority levels. The operations of 904 may be performed in accordance with examples as described herein. In some implementations, aspects of the operations of 904 may be performed by a UE as described with reference to FIG. 6.

At 906, the method may include selecting a timer configuration from the set of timer configurations based at least in part on the priority level associated with the SDU. The operations of 906 may be performed in accordance with examples as described herein. In some implementations, aspects of the operations of 906 may be performed a UE as described with reference to FIG. 6.

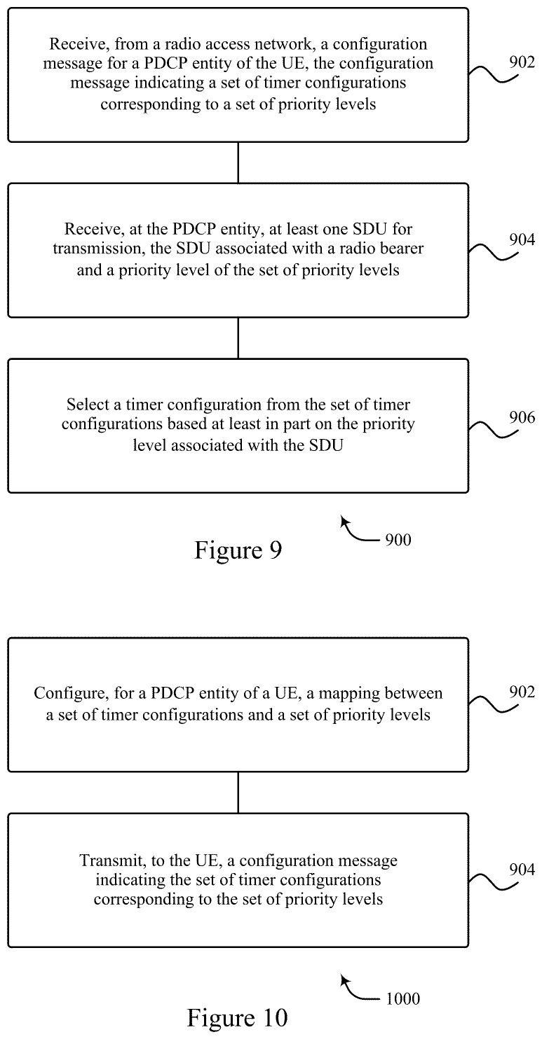

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include configuring, for a PDCP entity of a UE, a mapping between a set of timer configurations and a set of priority levels. The operations of 1002 may be performed in accordance with examples as described herein. In some implementations, aspects of the operations of 1002 may be performed by a NE as described with reference to FIG. 8.

At 1004, the method may include transmitting, to the UE, a configuration message indicating the set of timer configurations corresponding to the set of priority levels. The operations of 1004 may be performed in accordance with examples as described herein. In some implementations, aspects of the operations of 1004 may be performed by a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a radio access network, a configuration message for a packet data convergence protocol (PDCP) entity of the UE, the configuration message indicating a set of timer configurations corresponding to a set of priority levels;
receive, at the PDCP entity, at least one service data unit (SDU) for transmission, the SDU associated with a radio bearer and a priority level of the set of priority levels; and
select a timer configuration from the set of timer configurations based at least in part on the priority level associated with the SDU.

2. The UE of claim 1, wherein the at least one processor is configured to cause the UE to initiate a timer based at least in part on reception of the SDU associated with the radio bearer, and the timer configuration indicates a timer duration for the timer.

3. The UE of claim 2, wherein the timer is a PDCP discard timer.

4. The UE of claim 1, wherein the set of timer configurations includes at least a first timer configuration corresponding to a higher priority level of the set of priority levels, a second timer configuration corresponding to a lower priority level of the set of priority levels, and a third timer configuration corresponding to a legacy timer configuration.

5. The UE of claim 4, wherein the first timer configuration indicates a first timer duration that is greater than a second timer duration associated with the second timer configuration and a third timer duration associated with the third timer configuration.

6. The UE of claim 4, wherein, to select the timer configuration, the at least one processor is configured to cause the UE to select the first timer configuration based at least in part on the SDU being associated with the higher priority level.

7. The UE of claim 6, wherein the at least one processor is configured to cause the UE to initiate a first timer associated with the first timer configuration after expiry of a second timer associated with the legacy timer configuration.

8. The UE of claim 7, wherein the at least one processor is configured to cause the UE to initiate the first timer prior to delivery of the SDU to a lower layer for the transmission.

9. The UE of claim 7, wherein the at least one processor is configured to cause the UE to transmit the SDU prior to expiry of the first timer.

10. The UE of claim 7, wherein the at least one processor is configured to cause the UE to discard the SDU after expiry of the first timer.

11. The UE of claim 1, wherein the at least one processor is configured to cause the UE to determine the priority level associated with the SDU based at least in part on the SDU being a reference for decoding one or more other SDUs.

12. The UE of claim 1, wherein the at least one processor is configured to cause the UE to select the timer configuration based at least in part on protocol data unit (PDU) set importance (PSI)-based discard being enabled or disabled.

13. The UE of claim 1, wherein the configuration message indicates a mapping between the set of timer configurations and the set of priority levels.

14. The UE of claim 1, wherein each priority level of the set of priority levels corresponds to a respective protocol data unit (PDU) set importance (PSI) level.

15. The UE of claim 1, wherein the configuration message indicates a respective delay status report threshold associated with each timer configuration of the set of timer configurations.

16. The UE of claim 1, wherein the at least one processor is configured to cause the UE to receive protocol data unit (PDU) set information indicating at least one priority level of the set of priority levels, a PDU importance (PSI) level associated with the SDU, or whether the SDU is a reference for decoding one or more other SDUs.

17. The UE of claim 1, wherein the at least one processor is configured to cause the UE to indicate, within a PDCP header of the SDU, whether the SDU is to be delivered to an upper layer after expiry of a protocol data unit (PDU) set delay budget.

18. A processor for wireless communication, comprising:
at least one controller coupled with at least one memory and configured to cause the processor to:
receive, from a radio access network, a configuration message for a packet data convergence protocol (PDCP) entity associated with the processor, the configuration message indicating a set of timer configurations corresponding to a set of priority levels;
receive, at the PDCP entity, at least one service data unit (SDU) for transmission, the SDU associated with a radio bearer and a priority level of the set of priority levels; and
select a timer configuration from the set of timer configurations based at least in part on the priority level associated with the SDU.

19. A method performed by a user equipment (UE), the method comprising:
receiving, from a radio access network, a configuration message for a packet data convergence protocol (PDCP) entity of the UE, the configuration message indicating a set of timer configurations corresponding to a set of priority levels;
receiving, at the PDCP entity, at least one service data unit (SDU) for transmission, the SDU associated with a radio bearer and a priority level of the set of priority levels; and
selecting a timer configuration from the set of timer configurations based at least in part on the priority level associated with the SDU.

20. A network equipment for wireless communication, comprising:
at least one memory; and
at least one processor coupled with the at least one memory and configured to cause the network equipment to:
configure, for a packet data convergence protocol (PDCP) entity of a user equipment (UE), a mapping between a set of timer configurations and a set of priority levels; and
transmit, to the UE, a configuration message indicating the set of timer configurations corresponding to the set of priority levels.
